(19) United States
(12) Patent Application Publication
(10) Pub. No.: US 2024/0330047 A1
(43) Pub. Date: Oct. 3, 2024

(54) RESOURCE AWARE SCHEDULING FOR DATA CENTERS

(71) Applicant: International Business Machines Corporation, Armonk, NY (US)

(72) Inventors: Eun Kyung LEE, Bedford Corners, NY (US); Ramachandra Rao Kolluri, Cranbourne East (AU)

(21) Appl. No.: 18/127,835

(22) Filed: Mar. 29, 2023

(51) Int. Cl. G06F 9/48; G06F 9/50; G06N 20/00

(52) U.S. Cl. CPC G06F 9/4893; G06F 9/5005; G06N 20/00

(57) ABSTRACT

Provided is a method, system, and computer program product for using machine learning to allocate resources to workloads at run time in an optimized manner to minimize resource consumption. A processor may generate training data from a retrospective analysis of historical resource management data associated with a computing system. The processor may train a machine learning model to optimize resource management of the computing system at run time using the training data. The processor may obtain optimization recommendations for a current state of the computing system from the machine learning model. The processor may implement the optimization recommendations to manage the current state of the computing system.

### BACKGROUND

The present disclosure relates generally to resource management of data centers and, more specifically, to using machine learning to allocate resources to workloads at runtime in an optimized manner to minimize resource consumption.

In most data centers, unused servers are usually on standby (idle) and ready to accept various workloads. While in standby, the power consumed by a server is still substantial, making this idle power a significant contributor to overall data center energy consumption—both directly and indirectly (e.g., through cooling and peripheral energy consumption). To address this problem, sleep states have been designed to systematically deactivate different modules of a server, thus allowing the server to consume less power.

### SUMMARY

Embodiments of the present disclosure include a method, system, and computer program product for using machine learning to allocate resources to workloads at run time in an optimized manner to minimize resource consumption. A processor may generate training data from a retrospective analysis of historical resource management data associated with a computing system. The processor may train a machine learning model to optimize resource management of the computing system at run time using the training data. The processor may obtain optimization recommendations for a current state of the computing system from the machine learning model. The processor may implement the optimization recommendations to manage the current state of the computing system.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example machine learning (ML) scheduling system, in accordance with embodiments of the present disclosure.

FIG. 2 illustrates an example diagram for training an ML scheduler, in accordance with embodiments of the present disclosure.

FIG. 3 illustrates an example diagram for testing/implementation of a trained ML scheduler, in accordance with embodiments of the present disclosure.

FIG. 4 illustrates an example diagram for applying an optimized sleep state solution to a computing system, in accordance with embodiments of the present disclosure.

FIG. 5 illustrates a chart of example scenarios that may be applied during scenario planning using the ML scheduling system, in accordance with embodiments of the present disclosure.

FIG. 6 illustrates a flow diagram of an example process for generating and implementing an optimized sleep state solution, in accordance with some embodiments of the present disclosure.

FIG. 7 illustrates a flow diagram of an example process for resource allocation and fulfillment, in accordance with some embodiments of the present disclosure.

FIG. 8 illustrates a high-level block diagram of an example computer system that may be used in implementing one or more of the methods, tools, and modules, and any related functions, described herein, in accordance with embodiments of the present disclosure.

FIG. 9 depicts a schematic diagram of a computing environment for executing program code related to the methods disclosed herein and for ML scheduling management, according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to resource management of data centers and, more particularly, to using machine learning to allocate resources to workloads at runtime in an optimized manner to minimize resource consumption. While the present disclosure is not necessarily limited to such applications, various aspects of the disclosure may be appreciated through a discussion of various examples using this context.

In most data centers, unused servers are usually on standby (idle) and ready to accept various workloads. While in standby, the power consumed by a server is still substantial, making this idle power a significant contributor to overall data center energy consumption—both directly and indirectly (e.g., through cooling and peripheral energy consumption). To address this problem, sleep states have been designed to systematically deactivate different modules of a server, thus allowing the server to consume less power. However, the lower power consumption comes with an availability trade-off.

For example, though servers in sleep states consume less power, the given server will take time to come back to the idle state in order to be available to accept workloads. Further, deeper sleep states may result in even lower power consumption, but this results in lengthening the reactivation time it takes for the servers to become available. To find a balance between energy/cost savings versus server availability, many data centers utilize resource scaling to allocate sleep states. However, allocation of sleep states at run time is a complex problem and is usually done in a heuristic manner. For example, resource scaling may place a certain percentage of idle servers to sleep while keeping other servers active. This may result in power and/or delay inefficiencies. Further, a typical sleep state solution for resource scaling may be solved retrospectively, by using historical system data inputs to make resource allocation predictions. However, this complex problem takes time to solve and may become obsolete at run time, which also leads to resource management inefficiencies.

Embodiments of the present disclosure include a method, machine learning (ML) scheduling system, and computer program product that utilize machine learning to optimize allocation of resources to workloads at runtime while simultaneously applying an optimized sleep state solution to reduce power consumption and/or carbon intensity associated with the system.

In embodiments, the ML scheduling system may reduce data center energy and/or its carbon footprint by intelligently placing idle servers into different sleep states and waking them back up at runtime based on their transition delay and power characteristics. The ML scheduling system uses a novel model-based approach in which the retrospective sleep state solution(s) of an optimizer are used to train a machine learning model. Once trained, the machine learning model can find the optimal sleep state solution instantly, without needing to solve a comprehensive optimization problem. This allows the ML scheduling system to assist with instantaneous scheduling decisions at run time, which traditional server scheduling systems are incapable of.

Further, the proposed ML scheduling system may be complimentary to an existing computing system. For example, the ML scheduling system may determine and implement server availability for a load balancer of an existing computing system, such that load balancing mechanisms are applied to a ML determined subset of servers. In addition, the proposed system may dynamically optimize other aspects or modes associated with the servers and/or resources of the existing system. For example, the ML scheduling system may optimize server modes related to voltage and frequency scaling, where the voltage and frequency selection will affect the servers compute ability and power consumption. The ML scheduling system may optimize various server attributes in such a way to reduce server inefficiencies on runtime.

Experimental results using the ML scheduling system have shown as much as a 10% reduction in energy consumption in initial estimates. In this way, the ML scheduling system provides potentially significant energy cost savings and better utilization of equipment in data centers over their lifetime.

The aforementioned advantages are example advantages, and not all advantages are discussed. Furthermore, embodiments of the present disclosure can exist that contain all, some, or none of the aforementioned advantages while remaining within the spirit and scope of the present disclosure.

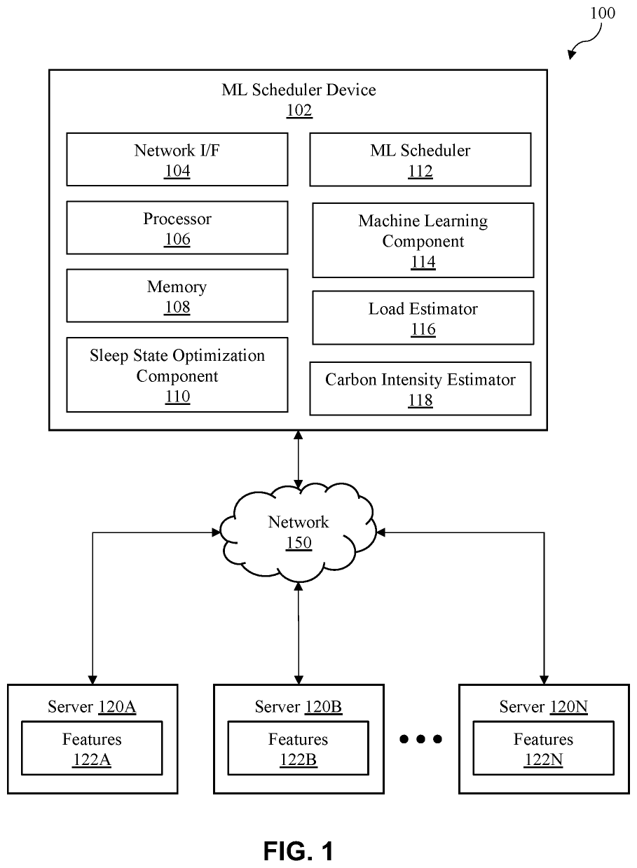

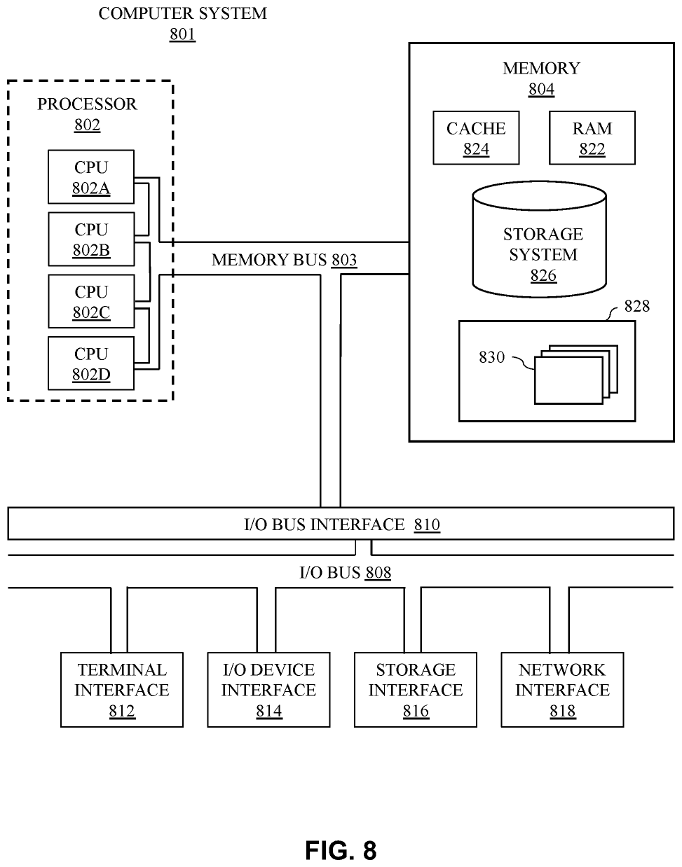

With reference now to FIG. 1, shown is a block diagram of an example machine learning (ML) scheduling system 100, in accordance with embodiments of the present disclosure. In the illustrated embodiment, ML scheduling system 100 includes ML scheduler device 102 that is communicatively coupled to server 120A, server 120B, and server 120N (collectively referred to as servers 120) via network 150. ML scheduler device 102 and servers 120 may be configured as any type of computer system and may be substantially similar to computer system 801 detailed in FIG. 8.

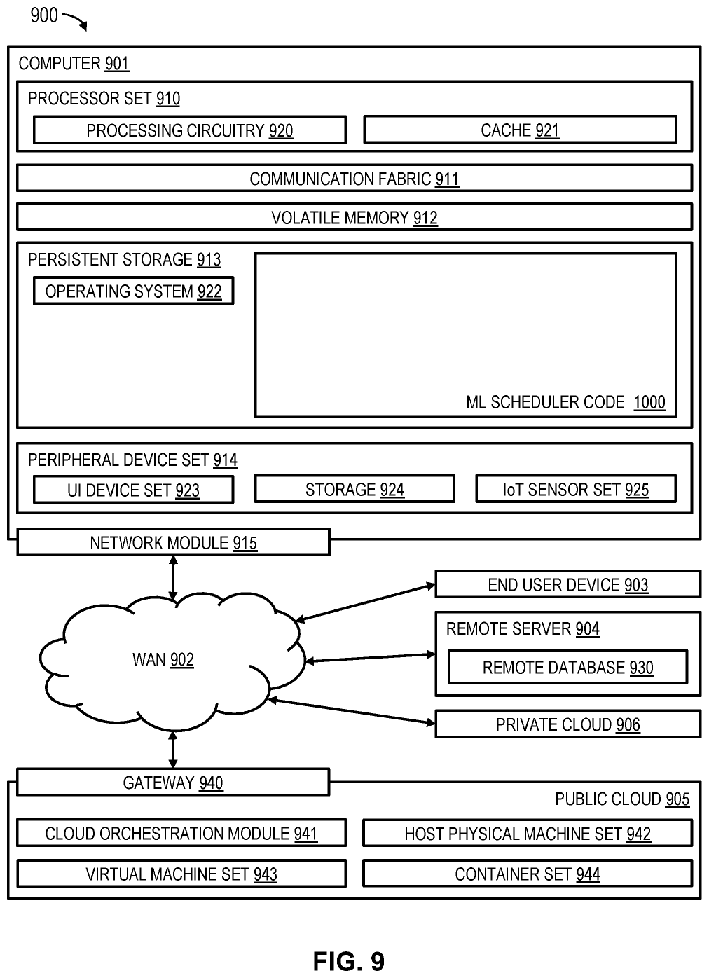

Network 150 may be any type of communication network, such as a wireless network or a cloud computing network. Network 150 may be substantially similar to, or the same as, a computing environment 900 described in FIG. 9. In some embodiments, network 150 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over network 150. In some embodiments, network 150 can be implemented using any number of any suitable communications media. For example, the network may be a wide area network (WAN), a local area network (LAN), a personal area network (PAN), an internet, or an intranet. In certain embodiments, the various systems may be local to each other, and communicate via any appropriate local communication medium. For example, ML scheduler device 102 may communicate with servers 120 using a WAN, one or more hardwire connections (e.g., an Ethernet cable), and/or wireless communication networks. In some embodiments, the various systems may be communicatively coupled using a combination of one or more networks and/or one or more local connections. For example, in some embodiments, ML scheduler device 102 may communicate with server 120A and server 120B using a hardwired connection, while communication between server 120N and ML scheduler device 102 may be through a wireless communication network.

In embodiments, servers 120 include features 122 or attributes (e.g., features 122A, features 122B, and features 122N, respectively) which may be any type of data feature or data input associated with each given server. For example, features 122 may comprise various data related to workloads, system state, power characteristics, delay characteristics related to sleep state, network traffic/demand, and/or carbon intensity associated with the given server(s) 120. Features may include data indicating energy consumption for servers at run-time and/or servers that are in an idle or sleep state. Features may include historical data features (past data) and/or current data features (real-time data) related to the servers 120 dependent on the time of collection. As would be recognized by one of ordinary skill in the art, other features may be extracted depending on the type of server, and the examples given herein should not be construed as limiting. In some embodiments, servers 120 may include some or similar components (e.g., processor, memory, machine learning component, etc.) as ML scheduler device 102, but for brevity purposes these components are not shown.

In the illustrated embodiment, ML scheduler device 102 includes network interface (I/F) 104, processor 106, memory 108, sleep state optimization (SSO) component 110, ML scheduler 112, machine learning component 114, load estimator 116, and carbon intensity estimator 118.

In embodiments, SSO component 110 is configured collect, extract, receive, and/or analyze various features 122 to determine an optimal set of sleep states for servers 120 of ML scheduling system 100 over a time period. SSO component 110 may receive features 122 via a load balancer (not shown) that include system state information (e.g., number of servers available, number of workloads running, levels of utilization, power characteristics, delay characteristics), carbon intensity, and or traffic/demand. Load estimator 116 may generate future load estimation inputs or load forecasts by analyzing features related to workload that are used by SSO component 110 when making sleep state decisions. Carbon intensity estimator 118 may generate future carbon intensity estimation inputs or forecasts that are used by SSO component 110 to determine optimal sleep state decisions that limit and/or reduce carbon intensity for servers 120. Using the inputs, the SSO component 110 may retrospectively generate a sleep state solution for servers 120 which includes outputs related to sever utilization management, server demand management, and sleep state selection for the given set of servers 120.

In embodiments, machine learning component 114 is configured to train ML scheduler 112 using the retrospective sleep state solution as inputs for a machine learning model. The machine learning component 114 may utilize the historical features 122 in addition to the retrospective sleep state solution to optimize sleep state selection at run-time of the ML scheduling system 100. In some embodiments, the machine learning component 114 may continuously run rounds of experiments to generate additional useful training data. For example, when a new set of inputs (such as new data inputs collected/received after implementing the optimized sleep state solution on the current state of the system) are presented to the trained machine learning model, it may prescribe sleep action based on the past actions for similar inputs. As the training data expands, the machine learning model is periodically retrained and/or refactored, resulting in increasingly accurate predictions of valid configuration parameter values that are likely to affect performance metrics of the ML scheduler 112. The results from prior experimentation are used to determine configuration and/or workload attribute variations and/or sleep state selection from which to gather data for future experiments. For example, machine learning component 110 may identify one or more experimental values for one or more configuration parameters based on determining that historical changes to the one or more configuration parameters had an impact on one or more performance metrics that is over a threshold amount of change. For example, the machine learning component may identify historical changes for energy consumption parameters based on given sleep state selection and optimize such parameters over time.

A machine learning model is trained using a particular machine learning algorithm. Once trained, input is applied to the machine learning model to make a prediction, which may also be referred to herein as a predicated output or output. A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process, such as ML scheduler device 102, executing a machine learning algorithm applies the model artifact against the input to generate a predicted output. A computer system process executes a machine learning algorithm by executing software configured to cause execution of the algorithm.

In some embodiments, feature synthesis may be performed. Feature synthesis is the process of transforming raw input into features that may be used as input to a machine learning model. Feature synthesis may also transform other features into input features. Feature engineering refers to the process of identifying features. A goal of feature engineering is to identify a feature set with higher feature predicative quality for a machine learning algorithm or model. Features with higher predicative quality cause machine learning algorithms and models to yield more accurate predictions. In addition, a feature set with high predicative quality tends to be smaller and require less memory and storage to store. A feature set with higher predicative quality also enables generation of machine learning models that have less complexity and smaller artifacts, thereby reducing training time and execution time when executing a machine learning model. Smaller artifacts also require less memory and/or storage to store.

In some embodiments, machine learning component 114 can utilize machine learning and/or deep learning, where algorithms or models can be generated by performing supervised, unsupervised, or semi-supervised training on historical data inputs and/or historical features. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

FIG. 1 is intended to depict the representative major components of ML scheduling system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with ML scheduling system 100 may not be present, and the arrangement of components may vary. For example, while FIG. 1 illustrates an example ML scheduling system 100 having a single ML scheduler device 102 and three servers 120 that are communicatively coupled via a single network 150, suitable network architectures for implementing embodiments of this disclosure may include any number of ML scheduler devices, servers, and networks. The various models, modules, systems, and components illustrated in FIG. 1 may exist, if at all, across a plurality of ML scheduler devices, servers, and networks.

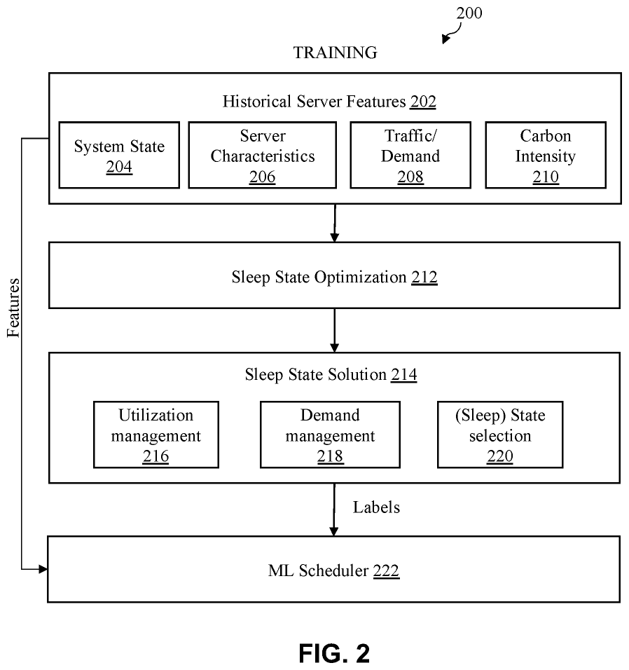

Referring now to FIG. 2, shown is an example diagram 200 for training an ML scheduler 222, in accordance with embodiments of the present disclosure. In embodiments, ML scheduler 222 may be substantially similar or the same as ML scheduler 112 of ML scheduler device 102 of FIG. 1. In embodiments, historical server features 202 are collected and analyzed by sleep state optimization (SSO) component 212. In the illustrated embodiment, historical server features 202 include system state 204, server characteristics 206, traffic/demand 208, and carbon intensity 210. As would be recognized by one of ordinary skill in the art, other features may be extracted depending on the type of server, and the examples given herein should not be construed as limiting.

In embodiments, SSO component 212 analyzes the historical server features 202 and generates a retrospective sleep state solution 202. The sleep state solution 202 includes utilization management 214, demand management 218, and (sleep) state selection 220 parameters that are configured to optimize resource scaling of servers associated with a data center based on the retrospective analysis of the historical data features of the given system.

In embodiments, ML scheduler 222 receives both the sleep state solution 214 and historical server features 202 to be used as training data for a machine learning model. The machine learning model trains on the inputs of the SSO component 212 as features and uses the sleep state solution 202 parameters as labels. In embodiments, the ML scheduler 222 is trained such that it can prescribe resource scaling and pseudo-optimal server sleep state selection on run time for the system/server (e.g., data center). In this way, the machine learning model can find the optimal sleep state solution instantly, without needing to solve a comprehensive optimization problem.

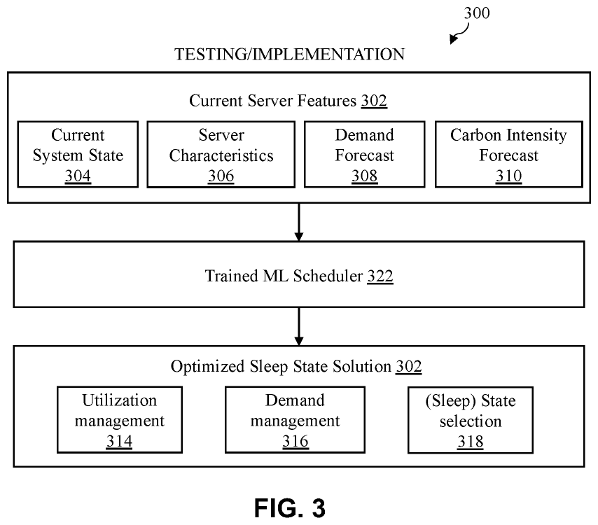

Referring now to FIG. 3, shown is an example diagram 300 for testing/implementation of a trained ML scheduler 322, in accordance with embodiments of the present disclosure. In embodiments, ML scheduler 322 may be substantially similar or the same as ML scheduler 112 of ML scheduler device 102 of FIG. 1. In the illustrated embodiment, the trained ML scheduler 322 collects/receives and analyzes the current (real-time) server features 302 as data inputs. The current server features 302 include current system state 304, server characteristics 306, demand forecast 309, and carbon intensity forecast 310.

Using the current server features 302 as a new set of inputs, the trained ML scheduler 322 may generate an optimized sleep state solution 302 that may be implemented on the servers of the system at run-time. The optimized sleep state solution 302 may include predictions for utilization management 314, demand management 316, and sleep state selection 318 for the servers of the given system. In this way, the trained ML scheduler is configured to prescribe sleep state and/or resource management actions based on the past actions for similar inputs instantly at runtime. Further, the optimized sleep state solution may include additional optimized server modes based on past/current inputs.

For example, the sleep state solution 302 may include dynamic voltage and frequency scaling modes, where the voltage and frequency selection will affect the servers compute ability and power consumption (e.g., increase certain compute abilities of certain servers, while reducing power consumption of other servers). In some embodiments, the optimized sleep state solution 302 may include a server availability schedule, wherein the server availability schedule is implemented by a load balancer to a subset of servers of the plurality of servers. In this way, the ML scheduler 422 may be complimentary to the load balancer of an existing system.

In embodiments, the trained ML scheduler 322 (or machine learning model) can be repeatedly retrained, as more data inputs are collected which can take into account changing conditions, such as changes in hardware (e.g., number and types of servers), time series seasonality, trends and changes (e.g., carbon intensity rise and fall, or changing frequency of workload arrival). Further, because the optimized sleep state solution is based on computationally intensive optimization and machine learning, the trained ML scheduler 322 may adjust flexible computation load to leverage the idle and/or low carbon intensity periods.

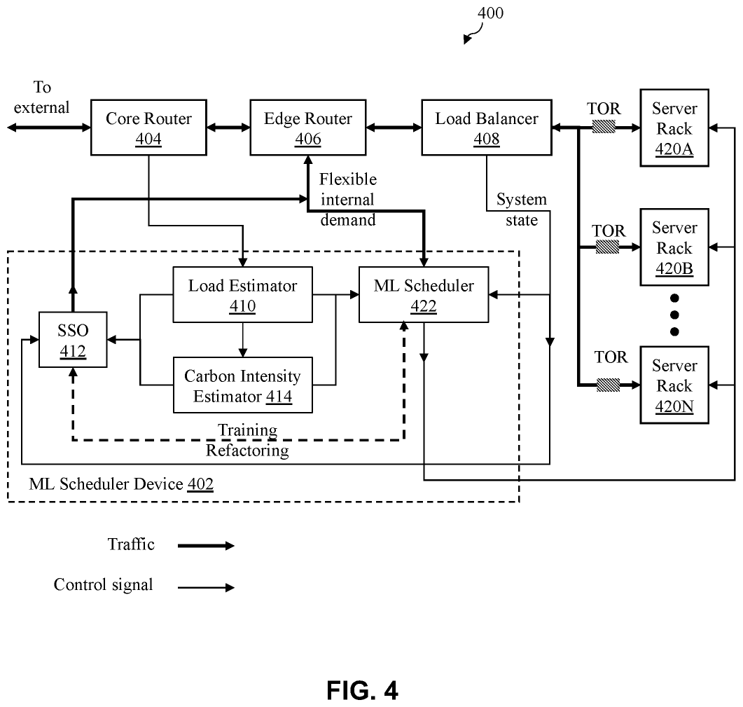

Referring now to FIG. 4, shown is an example diagram for applying an optimized sleep state solution to a computing system 400, in accordance with embodiments of the present disclosure. In the illustrated embodiment, computing system 400 includes ML scheduler device 402, core router 404, edge router 406, load balancer 408, server rack 420A, server rack 420B, and server rack 420N (collectively referred to as server racks 420) which are communicatively coupled over a network. In some embodiments, the computing system 400 may be configured as a data center that receives workload requests from an external source, processes the workload request, and allocates various task to the server racks 420 to be performed. ML scheduler device 402 is configured as a bypass mechanism where various workloads, traffic/demand, carbon intensity, and system state information are analyzed to determine a sleep state solution. The ML scheduler device 402 uses the retrospective sleep state solution as training data for a machine learning model, where the trained ML scheduler device 402 determines which servers need to be available for the incoming/anticipated workload and initiatives wake up sequencies on the given server or plurality of servers or server racks 420.

In the illustrated embodiment, the ML scheduler device 402 includes ML scheduler 422, load estimator 410, sleep state optimization (SSO) component 412, and carbon intensity estimator 414. In some embodiments, the ML scheduler device 402 may include additional components, such as described for ML scheduler device 102 in FIG. 1, however, for brevity purposes these components are not shown in FIG. 4.

In embodiments, one or more workloads and/or workload attributes (e.g., information, characteristics, etc.) are sent to and/or received by core router 404, where they are logged in at an ongoing or continuous manner. The workloads are passed through core router 404 to edge router 406 and further received by load balancer 408. Load balancer 408 is configured to assign the given workload(s) to at least one of a plurality of server racks 420 (or particular servers within the given rack).

In embodiments, the workloads and/or workload attributes may be sent to and/or received by load estimator 410. Load estimator 410 is configured to track and analyze the workloads and/or workload attributes in order to predict future workloads. Based on the analysis, load estimator 410 generates one or more future workload arrival forecasts pertaining to computing system 400.

In embodiments, carbon intensity estimator 414 collects/receives carbon intensity data from an external source. In some embodiments, the carbon intensity data may be sent to/received by carbon intensity estimator 414 along with the workload attributes via core router 404. Carbon intensity estimator 414 is configured to log and analyze the carbon intensity data to determine an estimated carbon intensity related to the given workload or predicted workload. Based on the analysis, carbon intensity estimator 414 generates one or more carbon intensity forecasts related to computing system 400.

In embodiments, load balancer 408 sends system state data to SSO component 412. The system state data may include various data inputs related to the state of the computing system 400. For example, system state data may include number of servers available, number of workloads running, levels of utilization, power characteristics, delay characteristics, and the like. SSO component 412 receives as inputs the system state data from load balancer 408, the future workload arrival forecasts load estimator 410, and the carbon intensity forecasts from the carbon intensity estimator 414. Using these inputs, the SSO component 412 retrospectively determines a sleep state solution for the server racks 420 over a time period based on historical data. The SSO component 412 may send the sleep state solution to ML scheduler 422 where the sleep state solution along with the inputs are used as training data for a machine learning model.

In embodiments, the machine learning model is trained using the given data/inputs to optimize the sleep state solution in an ongoing/continuous basis. For example, as new workloads arrive, the ML scheduler 422 uses this data, together with the carbon intensity forecasts, workload forecasts, and system state to determine what optimal sleep states each of the servers should be in at runtime, instantly. In this way, the ML scheduler 422 is configured to control which server rack 420 is to be in a given sleep state at any given time based on the optimized sleep state solution. In embodiments, the load balancer 408 reads the states of all the server and may decide how workloads are dispatched onto the server racks 420. However, server availability is manipulated and maintained by the ML scheduler 422 (or ML scheduler device 402) via a server availability schedule. In this way, the ML scheduler 422 may be complimentary to the load balancer of an existing system.

In embodiments, load balancer 408 communicates the ongoing system state to the ML scheduler 422 and SSO component 412, such that the SSO component 412 can repeatedly generate sleep state solution to generate data that is used in retraining the ML scheduler 422, such that an optimized sleep state solution may be continuously determined/predicted at run time.

In some embodiments, the ML scheduler 422 initiates start-up sequences for server racks 420 to make them available in advance for the load balancer 408 to allocate the anticipated workloads. In embodiments, when a new set of inputs are presented to the trained ML scheduler 422, it may prescribe sleep state actions based on past actions for similar inputs. The ML scheduler 422 may also suggest optimal allocation of (batches) workloads to each server or a cluster of servers.

In some embodiments, the trained ML scheduler 422 may gain insights that can be used to refactor the SSO component 412. This may be performed by analyzing the generated sleep state solution(s). For example, the sleep state solution may comprise a plurality of sleep states for each given server rack 420. Sleep states may include:
S0: the run state, wherein the server is fully running;
S1: the suspend state, wherein the CPU will suspend activity but retain its contexts;
S2: sleep state, wherein memory contexts are held but CPU contexts are lost;
S3: sleep state, which is similar to S2, but wherein CPU re-initialization is performed by firmware and device re-initialization;
S4: sleep state, wherein contexts are saved to disk, and wherein the context will be restored upon the return to S0 (this state may be identical to soft-off for hardware and may be implemented by either the OS or firmware); and
S5: the soft-off state, wherein all activity will stop and all context are lost. In some embodiments, the sleep states may also reflect frequency scaled states, wherein the frequency of a server is tuned down to save energy and restored upon request.

The ML scheduler 422 may determine that during training (or retraining) S3 has rarely been prescribed because it is rarely chosen as a label by the SSO component 412 during optimization of the sleep state solution, or the power vs delay is not leverage-able for any energy savings in practice. During refactoring, the ML scheduler 422 may disable S3 in its model, which reduces its search space and allows the SSO component 412 to solve the sleep state solution at a faster pace. In this way, by using refactoring, the ML scheduler 422 may improve its predictions for applying optimized sleep state solutions. In some embodiments, refactoring may be performed automatically using machine learning. However, in some embodiments, refactoring may be manually implemented. For example, the refactoring can be based on a time-triggered value (e.g., check for refactoring every few seconds, minutes, hours, etc.). In some embodiments, the refactoring may be triggered conditionally (e.g., rule based). For example, the ML scheduler may implement refactoring if a given state is not selected for 1 hour. In some embodiments, the disabled state may be randomly enabled in future refactoring steps to avoid any unforeseen bias.

In some embodiments, ML scheduler 422 may leverage various machine learning methods/models as required for flexible demand. For example, internal workloads can be used in optimization as flexible components in order to leverage compute low carbon periods.

In embodiments, ML scheduler 422 may apply optimized sleep state solutions to one or more subsets of servers. For example, only a subset of servers may be activated by the ML scheduler 422 in order to keep the subset reactive, non-disruptive, and complimentary to workload demands.

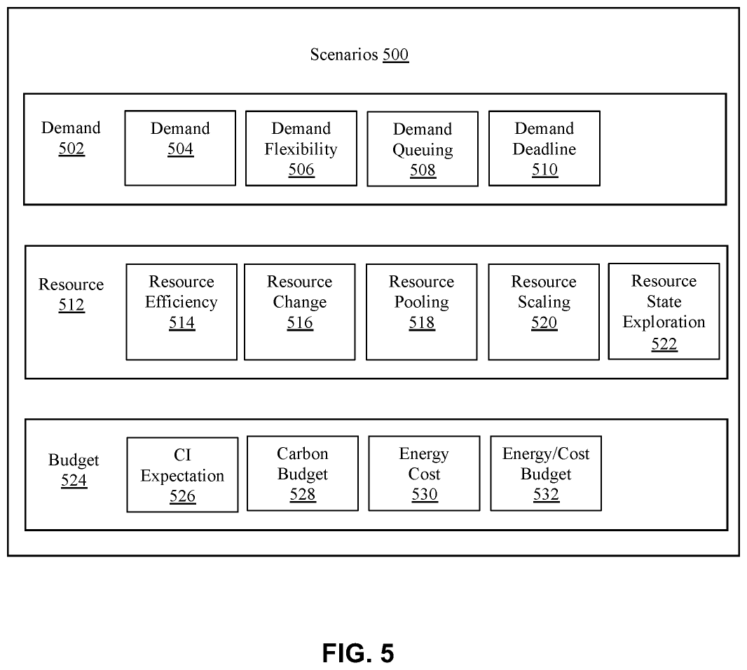

Referring now to FIG. 5, shown is a chart 500 of example scenarios that may be applied during scenario planning using the ML scheduling system, in accordance with embodiments of the present disclosure. The ML scheduling system (e.g., ML scheduling system 100 detailed in FIG. 1) may implement various solutions for resource allocation and fulfillment that may be optimized for a given scenario 500. For example, the ML scheduling system may be applied to various demand scenarios 502, resource scenarios 512, and/or budget scenarios 524.

In some embodiments, demand scenarios 502 may include scenarios that capture various changes in demand 504 (e.g., demand forecast on the system), demand flexibility 506, demand queuing 508, and demand deadline 510 (e.g., workload priorities, deadlines, etc.). The ML scheduling system is configured to optimize system resources to best meet the demand scenarios 502. For example, the ML scheduling system may optimize various demand characteristics/resources of the current system on runtime using the trained ML model.

In some embodiments, resource scenarios 512 may include scenarios that capture various changes in resource efficiency 514, resource change 516, resource pooling 518 (e.g., changes to the structure of the resource pool), resource scaling 520 (e.g., changes to resource scaling algorithms), and resource state exploration 512 (e.g., changes to newer states of the given resource of the system). Dependent on the given resource scenario 512, the ML scheduling system is trained to optimize resources based on availability at runtime. For example, the ML scheduling system may optimize various changes in resource availability (e.g., new resources added, old resources removed, changes in scaling requirements, etc.) of the current system on runtime using the trained ML model.

In some embodiments, budget scenarios 524 may include scenarios that capture various changes in carbon intensity (CI) expectation 526 (e.g., newer carbon forecasts), carbon budget 528, energy cost 530, and energy/cost budget 532 scenarios (e.g., changes in energy/price forecasts, etc.). In some embodiments, the ML scheduling system may utilize budgeting factors (e.g., resource costs, energy costs, and the like) when determining an optimized solution at runtime for the current system. In this way, the ML scheduling system may consider various budget scenarios when determining an optimized solution for resource management/allocation of a given computing system.

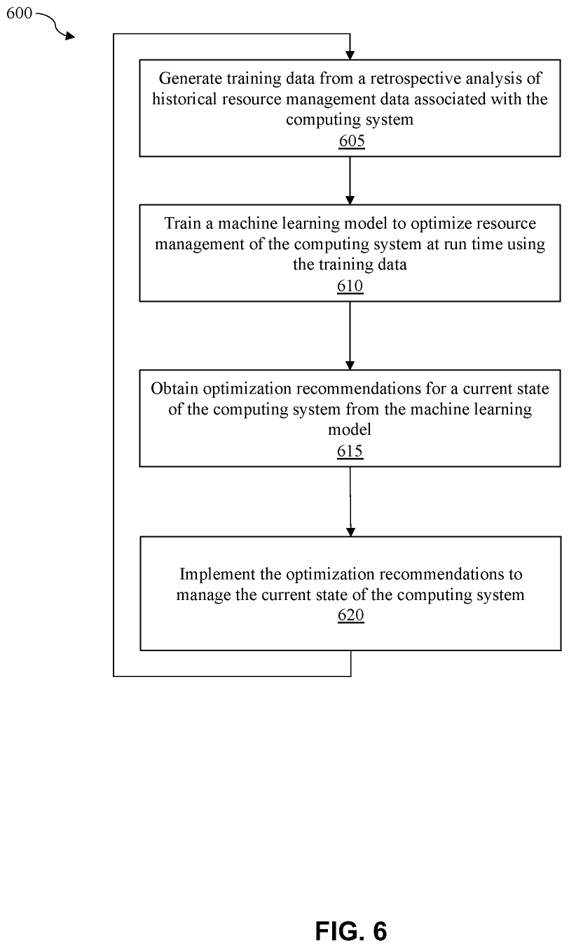

Referring now to FIG. 6, shown is an example process 600 for generating and implementing an optimized sleep state solution, in accordance with some embodiments of the present disclosure. The process 600 may be performed by processing logic that comprises hardware (e.g., circuitry, dedicated logic, programmable logic, microcode, etc.), software (e.g., instructions run on a processor), firmware, or a combination thereof. In some embodiments, the process 600 is a computer-implemented process. In embodiments, the process 600 may be performed by processor 106 of ML scheduler device 102 exemplified in FIG. 1.

The process 600 begins by generating training data from a retrospective analysis of historical resource management data associated with the computing system. This is illustrated at step 605. In embodiments, the computing system may be configured as a data center comprising a plurality of servers. In embodiments, the retrospective analysis of the historical resource management data may be performed using a sleep state optimization (SSO) component (e.g., SSO component 110 or FIG. 1). The sleep state optimization component may collect and/or extract a set of historical data features from the plurality of servers associated with the computing system. The historical data features may include various input data used to predict resource management decisions. For example, the historical data features may include system state data (number of servers available, number of workloads running, levels of utilization, and the like), server characteristics (power/delay characteristics, energy consumption, etc.), carbon intensity data, and server traffic/demand data. The SSO component may analyze the set of historical data features to determine a sleep state solution for the plurality of servers, where the sleep state solution comprises a plurality of sleep state recommendations for the plurality of servers. Based on the analysis, the SSO component may generate the sleep state solution for managing sleep states for the plurality of servers, where the sleep state solution is used as training data for a machine learning model as detailed in the following step. In some embodiments, the sleep state solution may include a server availability schedule, wherein the server availability schedule is implemented by a load balancer to a subset of servers of the plurality of servers of the computing system. In some embodiments, the sleep state solution may include a voltage and scaling mode for each of the plurality of servers, wherein the voltage and scaling mode are associated with compute ability and power consumption associated with the plurality of servers.

The process 600 continues by training a machine learning model to optimize resource management of the computing system at run time using the training data. This is illustrated at step 610. For example, the ML scheduler device may utilize the retrospective sleep state solution and historical server features to be used as training data for a machine learning model. The machine learning model trains on the inputs of the SSO component as features and uses the sleep state solution parameters as labels. In embodiments, the ML scheduler device is trained such that it can prescribe resource scaling and pseudo-optimal server sleep state selection on run time for the system/server (e.g., data center). In this way, the machine learning model can find the optimal sleep state solution/resource allocation instantly, without needing to solve a comprehensive optimization problem.

The process 600 continues by obtaining optimization recommendations for a current state of the computing system from the machine learning model. This is illustrated at step 615. For example, the ML scheduler device may obtain an optimized sleep state solution that includes a plurality of sleep state recommendations to be applied at run time for a plurality of servers of the computing system. The plurality of sleep state recommendations may be configured to reduce energy/power consumption at a highest rate while maintaining server availability. In some embodiments, the optimized recommendations are configured to reduce carbon intensity values related to the computing system without sacrificing performance of the computing system. In some embodiments, the optimized sleep state solution may include an optimized server availability schedule, wherein the server availability schedule is implemented by a load balancer to a subset of servers of the plurality of servers of the computing system. In some embodiments, the sleep state solution may include an optimized voltage and scaling mode for each of the plurality of servers, wherein the voltage and scaling mode are associated with compute ability and power consumption associated with the plurality of servers.

The process 600 continues by implementing the optimization recommendations to manage the current state of the computing system. This is illustrated at step 620. In embodiments, the ML scheduler device is configured to utilize the optimization recommendation to determine which servers are required to be available for the incoming (anticipated) workloads and initiate wake up sequences on those particular servers (sets of servers) in a pseudo-optimal manner.

In some embodiments, the process 600 continues by retraining the machine learning model and/or the ML scheduler device by returning to step 605. In some embodiments, the ML scheduler device may collect a second set of training data based, in part, on the implemented optimization recommendations to manage the current state of the computer system. Using this second set of training data, the ML scheduler device may retrain the machine learning model to continuously optimize the resource management of the computing system. In this way, the ML scheduler device may continuously retrain itself to improve predictions for providing optimization recommendations for resource scaling and sleep state selection at run time.

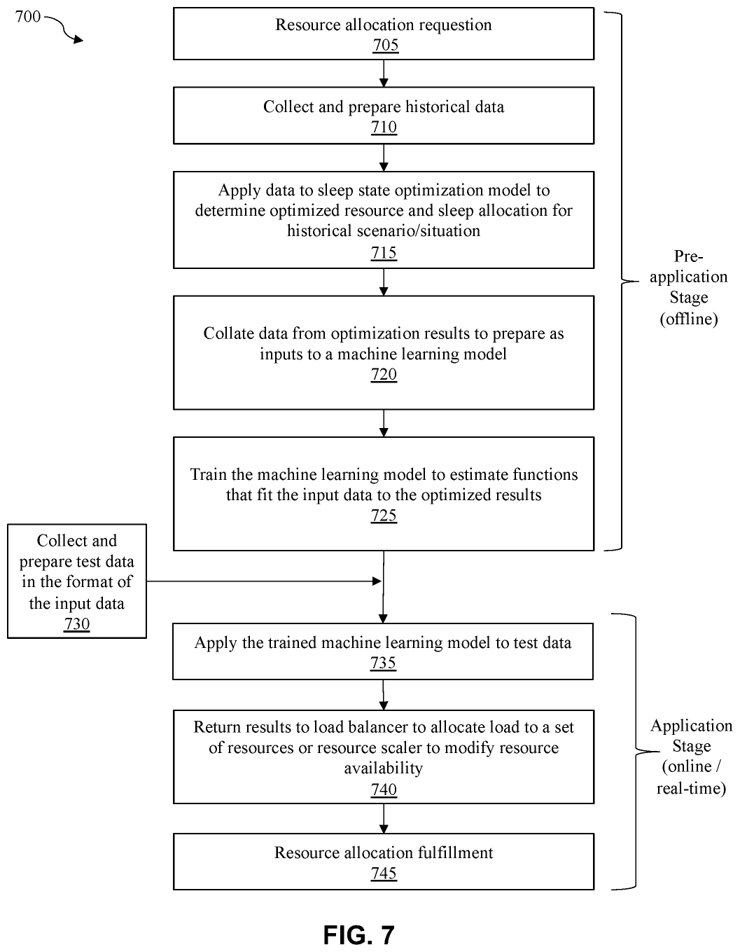

Referring now to FIG. 7, shown is an example process 700 for resource allocation and fulfillment, in accordance with some embodiments of the present disclosure. The process 700 may be performed by processing logic that comprises hardware (e.g., circuitry, dedicated logic, programmable logic, microcode, etc.), software (e.g., instructions run on a processor), firmware, or a combination thereof. In some embodiments, the process 700 is a computer-implemented process. In some embodiments, the process 700 may be a sub-process and/or include steps that are in addition to process 600. In embodiments, the process 700 may be performed by processor 106 of ML scheduler device 102 exemplified in FIG. 1.

The process 700 begins by receiving a resource allocation requisition for a computing system. This is illustrated at step 705. The resource allocation requisition may indicate various assets of the computing system that require resource management improvements that support various planning goals. For example, the resource allocation requisition may include requirements for improving management of system resources, such as server availability, sleep state selection, carbon intensity, and power consumption demands.

The process 700 continues by collecting and preparing historical data. This is illustrated at step 710. The historical data may include various data types related to historical scenarios that have been experienced by the computing system. For example, the historical data may include various demand data related to server flexibility, resource availability data, and/or resource characteristic data. The data may be collected and prepared as data inputs for a sleep state optimization model (e.g., sleep state optimization component 110 of FIG. 1).

The process 700 continues by applying the data inputs to the sleep state optimization model to determine an optimized resource and sleep allocation for the historical scenario based on an analysis of the historical data. This is illustrated at step 715. For example, the sleep state optimization model may determine how to best allocate resources and/or sleep states of servers based on the historical data.

The process 700 continues by collating data from the optimization results to prepare as inputs to train a machine learning model. This is illustrated at step 720. The ML scheduling system may collect the optimization results and organize the results as input for training the machine learning model to optimize resources on runtime.

The process 700 continues by training the machine learning model to estimate functions that fit the input data to the optimization results. This is illustrated at step 725. The machine learning model trains on the inputs of the SSO model as features and uses the sleep state solution parameters as labels. In embodiments, the machine learning model is trained such that it can prescribe resource scaling and pseudo-optimal server sleep state selection on run time for the system/server (e.g., data center). In embodiments, steps 705-725 may be classified as pre-application stage (offline) steps. For example, these steps are implemented using historical data (e.g., historical resource allocation, resource scaling, and/or sleep selection data).

The process 700 continues by collecting and preparing test data in the format of the input data. This is illustrated at step 730. The ML scheduling system may utilize a set of testing data collected from the current computing system to determine efficiencies of the trained ML model. The data may be collected and prepared such that it may be input in a proper format for ingesting by the trained ML model. The process 700 continues by applying the trained machine learning model to the test data. This is illustrated at step 735. The results from applying the trained ML model to the test data may be analyzed to see if improvement in resource scaling and/or sleep state selection on runtime has been improved/optimize. For example, resource scaling data and sleep state selection data may indicate a decrease in resource/power consumption and/or a reduction in carbon intensity.

The process 700 continues by returning results to a load balancer to allocate load to a set of resources or resource scaler to modify resource availability. This is illustrated at step 740. For example, based on the results from applying the test data, the ML scheduling system may implement the optimized resource scaling and/or sleep state solutions to improve resource allocation efficiencies. In some embodiments, the ML scheduling system may determine a server availability schedule, where the server availability schedule is implemented by a load balancer to a subset of servers of the plurality of servers of the computing system. In this way, the ML scheduling system may be complimentary to existing load balancing framework. In some embodiments, the ML scheduling system may optimize various voltage and scaling modes for each of the plurality of servers, wherein the voltage and scaling mode are associated with compute ability and power consumption associated with the plurality of servers. In some embodiments, the ML scheduling system may optimize allocation of resources to workloads at runtime while simultaneously applying an optimized sleep state solution to reduce power consumption and/or carbon intensity associated with the system.

The process 700 continues by implementing the solution for resource allocation fulfillment. This is illustrated at step 745. For example, the ML scheduling system will implement the best or most optimized solution at run time for resource allocation fulfillment using the trained ML model. In embodiments, steps 735-745 may be classified as application stage (online/real-time) steps. For example, the steps are implemented using real-time and/or current system data. In some embodiments, the ML scheduling system may performing retraining with current system data to continuously improve its resource allocation and fulfillment algorithms. In this way, the ML scheduling system provides potentially significant energy cost savings and better utilization of equipment in data centers over their lifetime.

In embodiments, the present disclosure provides a technical solution for consolidation and sleep state optimization for minimizing carbon intensity using the following equations:

$$X ϵ {( nXsXT )}^{} , , β ϵ {( nXT )}^{} {\sum }_{t = 1}^{T} {CI}_{t} {\sum }_{n = 1}^{N} ( {x}_{n} , 1 , {t}^{U} n , t ( {β}_{n , t} {P}_{linear 2 , n} + ( 1 - {β}_{n , t} ) {P}_{linear 1 , n} ) + {\sum }_{s = 1}^{S} {x}_{n , s , t} {P}_{idle , n , s} )$$

such that:

Single active state per server:

$${\sum }_{s = 1}^{S} {x}_{n , s , t} = 1 \qquad ∀ n ϵ , t ϵ$$

Utilization per server:

$$0 \leq {u}_{n , t} \leq 1 \qquad ∀ n ϵ , t ϵ$$

Cumulative utilization:

$${\sum }_{n = 1}^{N} {x}_{n , 1 , t {U}_{n , t}} \geq \overline{{U}_{t}} \qquad ∀ t ϵ$$

Inter sleep-state transition:

$$if {x}_{n , s , t} = 1 \\ then {x}_{n , s , t + 1} + {x}_{n , 1 , t + 1} = 1 \\ ∀ n ϵ𝒩 , s ϵ𝒮 - \{ 1 \} , t ϵ𝒯 - \{ T \}$$

Transition delay:

$$if {x}_{n , s , t + 1} = 1 and {x}_{n , 1 , t} = 1 \\ then {\sum }_{{t}^{′} = t + 1}^{min ( t + {d}_{n , s , T )}} {x}_{n , s , {t}^{′}} = min ( T - t , {d}_{n , s} ) \\ ∀ n ϵ𝒩 , s ϵ𝒮 - \{ 1 \} , t ϵ𝒯 - \{ T \}$$

For linearizing transition delay, another binary variable is added for linearization of logical constraints. α_{n,s,t+1} is added so that α_{n,s,t+1}=1 if x_{n,s,t+1}=1 and x_{n,1,t}=1; otherwise 0, wherein M is a large number:

$${α}_{n , s , t + 1} \geq {x}_{n , s , t + 1} + {x}_{n , 1 , t} - 1 \\ M ( {α}_{n , s , t + 1} - 1 ) \leq {x}_{n , s , t + 1} + {x}_{n , 1 , t} - 2 \\ ∀ n ϵ s ϵ - \{ 1 \} , t ϵ - \{ T \}$$

The equation may be modified by using the new binary variable a, such that:

$${\sum }_{{t}^{′} = t + 1}^{min ( t + {d}_{n , s , T )}} {x}_{n , s , {t}^{′}} \geq min ( T - t , {d}_{n , s} ) {α}_{n , s , t + 1} \\ ∀ n ϵ , s ϵ - \{ 1 \} , t ϵ$$

For linearizing piecewise linear power vs. utilization cure, a binary variable β_{n,t}=1 when u_{n,t}≥ûₙ and 0 otherwise, wherein His a large number:

$${u}_{n , t} - {\hat{u}}_{n} \leq H {β}_{n , t} \\ {\hat{u}}_{n} - {u}_{n , t} \leq H ( 1 - {β}_{n , t} ) \\ ∀ n ϵ , t ϵ$$

For adding flexible load (utilization):

$${\sum }_{n = 1}^{N} {\sum }_{t = 1}^{T} {U}_{n , t} \geq {\sum }_{t = 1}^{T} {U}_{dc , t} + {U}_{dc , flex , t}$$

wherein U_{dc,flex,t} is the flexible data center level utilization.

Referring now to FIG. 8, shown is a high-level block diagram of an example computer system 801 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 801 may comprise one or more CPUs 802, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface 810.

The computer system 801 may contain one or more general-purpose programmable central processing units (CPUs) 802A, 802B, 802C, and 802D, herein generically referred to as the CPU 802. In some embodiments, the computer system 801 may contain multiple processors typical of a relatively large system; however, in other embodiments the computer system 801 may alternatively be a single CPU system. Each CPU 802 may execute instructions stored in the memory subsystem 804 and may include one or more levels of on-board cache. In some embodiments, a processor can include at least one or more of, a memory controller, and/or storage controller. In some embodiments, the CPU can execute the processes included herein (e.g., process 600 and 700 as described in FIG. 6 and FIG. 7, respectively). In some embodiments, the computer system 801 may be configured as ML scheduling system 100 of FIG. 1.

System memory subsystem 804 may include computer system readable media in the form of volatile memory, such as random-access memory (RAM) 822 or cache memory 824. Computer system 801 may further include other removable/non-removable, volatile/non-volatile computer system data storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 804 can include flash memory, e.g., a flash memory stick drive or a flash drive. Memory devices can be connected to memory bus 803 by one or more data media interfaces. The memory subsystem 804 may include at least one program product having a set (e.g., at least one) of program modules that are configured to carry out the functions of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 810 and the I/O bus 808 are shown as single units, the computer system 801 may, in some embodiments, contain multiple I/O bus interfaces 810, multiple I/O buses 808, or both. Further, while multiple I/O interface units are shown, which separate the I/O bus 808 from various communications paths running to the various I/O devices, in other embodiments some or all of the I/O devices may be connected directly to one or more system I/O buses.

In some embodiments, the computer system 801 may be a multi-user mainframe computer system, a single-user system, or a server computer or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smart phone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

One or more programs/utilities 828, each having at least one set of program modules 830 may be stored in memory subsystem 804. The programs/utilities 828 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 828 and/or program modules 830 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

Embodiments of the present disclosure may be implemented together with virtually any type of computer, regardless of the platform is suitable for storing and/or executing program code. FIG. 9 shows, as an example, a computing environment 900 (e.g., cloud computing system) suitable for executing program code related to the methods disclosed herein and for ML scheduling and resource scaling management. In some embodiments, the computing environment 900 may be the same as or an implementation of the computing environment 100.

Computing environment 900 contains an example of an environment for the execution of at least some of the computer code involved in performing the inventive methods, such as ML scheduler code 1000. The ML scheduler code 1000 may be a code-based implementation of the autonomous vehicle management system 100. In addition to ML scheduler code 1000, computing environment 900 includes, for example, a computer 901, a wide area network (WAN) 902, an end user device (EUD) 903, a remote server 904, a public cloud 905, and a private cloud 906. In this embodiment, the computer 901 includes a processor set 910 (including processing circuitry 920 and a cache 921), a communication fabric 911, a volatile memory 912, a persistent storage 913 (including operating a system 922 and the ML scheduler code 1000, as identified above), a peripheral device set 914 (including a user interface (UI) device set 923, storage 924, and an Internet of Things (IoT) sensor set 925), and a network module 915. The remote server 904 includes a remote database 930. The public cloud 905 includes a gateway 940, a cloud orchestration module 941, a host physical machine set 942, a virtual machine set 943, and a container set 944.

The computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 930. As is well understood in the art of computer technology, and depending upon the technology, performance of a computer-implemented method may be distributed among multiple computers and/or between multiple locations. On the other hand, in this presentation of the computing environment 900, detailed discussion is focused on a single computer, specifically the computer 901, to keep the presentation as simple as possible. The computer 901 may be located in a cloud, even though it is not shown in a cloud in FIG. 1. On the other hand, the computer 901 is not required to be in a cloud except to any extent as may be affirmatively indicated.

The processor set 910 includes one, or more, computer processors of any type now known or to be developed in the future. The processing circuitry 920 may be distributed over multiple packages, for example, multiple, coordinated integrated circuit chips. The processing circuitry 920 may implement multiple processor threads and/or multiple processor cores. The cache 921 is memory that is located in the processor chip package(s) and is typically used for data or code that should be available for rapid access by the threads or cores running on the processor set 910. Cache memories are typically organized into multiple levels depending upon relative proximity to the processing circuitry. Alternatively, some, or all, of the cache for the processor set may be located “off chip.” In some computing environments, the processor set 910 may be designed for working with qubits and performing quantum computing.

Computer readable program instructions are typically loaded onto the computer 901 to cause a series of operational steps to be performed by the processor set 910 of the computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 921 and the other storage media discussed below. The program instructions, and associated data, are accessed by the processor set 910 to control and direct performance of the inventive methods. In the computing environment 900, at least some of the instructions for performing the inventive methods may be stored in the ML scheduler code 1000 in the persistent storage 913.

The communication fabric 911 is the signal conduction path that allows the various components of the computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 912 is any type of volatile memory now known or to be developed in the future. Examples include dynamic type random access memory (RAM) or static type RAM. Typically, the volatile memory 912 is characterized by random access, but this is not required unless affirmatively indicated. In the computer 901, the volatile memory 912 is located in a single package and is internal to the computer 901, but, alternatively or additionally, the volatile memory may be distributed over multiple packages and/or located externally with respect to the computer 901.

The persistent storage 913 is any form of non-volatile storage for computers that is now known or to be developed in the future. The non-volatility of this storage means that the stored data is maintained regardless of whether power is being supplied to the computer 901 and/or directly to the persistent storage 913. The persistent storage 913 may be a read only memory (ROM), but typically at least a portion of the persistent storage allows writing of data, deletion of data and re-writing of data. Some familiar forms of persistent storage include magnetic disks and solid state storage devices. The operating system 922 may take several forms, such as various known proprietary operating systems or open source Portable Operating System Interface-type operating systems that employ a kernel. The code included in the ML scheduler code 1000 typically includes at least some of the computer code involved in performing the inventive methods.

The peripheral device set 914 includes the set of peripheral devices of the computer 901. Data communication connections between the peripheral devices and the other components of the computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 923 may include components such as a display screen, speaker, microphone, wearable devices (such as goggles and smart watches), keyboard, mouse, printer, touchpad, game controllers, and haptic devices. The storage 924 is external storage, such as an external hard drive, or insertable storage, such as an SD card. The storage 924 may be persistent and/or volatile. In some embodiments, the storage 924 may take the form of a quantum computing storage device for storing data in the form of qubits. In embodiments where the computer 901 is required to have a large amount of storage (for example, where the computer 901 locally stores and manages a large database) then this storage may be provided by peripheral storage devices designed for storing very large amounts of data, such as a storage area network (SAN) that is shared by multiple, geographically distributed computers. The IoT sensor set 925 is made up of sensors that can be used in Internet of Things applications. For example, one sensor may be a thermometer and another sensor may be a motion detector.

The network module 915 is the collection of computer software, hardware, and firmware that allows the computer 901 to communicate with other computers through the WAN 902. The network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 915 are performed on the same physical hardware device. In other embodiments (for example, embodiments that utilize software-defined networking (SDN)), the control functions and the forwarding functions of the network module 915 are performed on physically separate devices, such that the control functions manage several different network hardware devices. Computer readable program instructions for performing the inventive methods can typically be downloaded to the computer 901 from an external computer or external storage device through a network adapter card or network interface included in the network module 915.

The WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 903 is any computer system that is used and controlled by an end user (for example, a customer of an enterprise that operates the computer 901) and may take any of the forms discussed above in connection with the computer 901. The EUD 903 typically receives helpful and useful data from the operations of the computer 901. For example, in a hypothetical case where the computer 901 is designed to provide a recommendation to an end user, this recommendation would typically be communicated from the network module 915 of the computer 901 through the WAN 902 to the EUD 903. In this way, the EUD 903 can display, or otherwise present, the recommendation to an end user. In some embodiments, the EUD 903 may be a client device, such as thin client, heavy client, mainframe computer, desktop computer and so on.

The remote server 904 is any computer system that serves at least some data and/or functionality to the computer 901. The remote server 904 may be controlled and used by the same entity that operates computer 901. The remote server 904 represents the machine(s) that collect and store helpful and useful data for use by other computers, such as the computer 901. For example, in a hypothetical case where the computer 901 is designed and programmed to provide a recommendation based on historical data, then this historical data may be provided to the computer 901 from the remote database 930 of the remote server 904.

The public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 905 is performed by the computer hardware and/or software of the cloud orchestration module 941. The computing resources provided by the public cloud 905 are typically implemented by virtual computing environments that run on various computers making up the computers of the host physical machine set 942, which is the universe of physical computers in and/or available to the public cloud 905. The virtual computing environments (VCEs) typically take the form of virtual machines from the virtual machine set 943 and/or containers from the container set 944. It is understood that these VCEs may be stored as images and may be transferred among and between the various physical machine hosts, either as images or after instantiation of the VCE. The cloud orchestration module 941 manages the transfer and storage of images, deploys new instantiations of VCEs and manages active instantiations of VCE deployments. The gateway 940 is the collection of computer software, hardware, and firmware that allows the public cloud 905 to communicate through the WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 906 is similar to the public cloud 905, except that the computing resources are only available for use by a single enterprise. While the private cloud 906 is depicted as being in communication with the WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 905 and the private cloud 906 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 922 and the ML scheduler code 1000 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for a machine learning based scheduler to recommend resource management of a computing system at run time, comprising:
generating training data from a retrospective analysis of historical resource management data associated with the computing system;
training a machine learning model to optimize resource management of the computing system at run time using the training data;
obtaining optimization recommendations for a current state of the computing system from the machine learning model; and
implementing the optimization recommendations to manage the current state of the computing system.

2. The method of claim 1, wherein generating the training data from the retrospective analysis of historical resource management data comprises:
collecting a set of historical data features from a plurality of servers associated with the computing system;
analyzing the set of historical data features to determine a sleep state solution for the plurality of servers, wherein the sleep state solution comprises a plurality of sleep state recommendations for the plurality of servers; and
generating the sleep state solution for managing sleep states for the plurality of servers, wherein the sleep state solution is used as the training data for the machine learning model.

3. The method of claim 2, wherein the historical data features are chosen from a group of data features consisting of: system state data, server characteristics, carbon intensity data, and server traffic/demand data.

4. The method of claim 2, wherein the sleep state solution is based on a carbon intensity forecast associated with the plurality of servers.

5. The method of claim 2, wherein the sleep state solution includes a server availability schedule.

6. The method of claim 2, wherein the sleep state solution includes a voltage and scaling mode for each server of the plurality of servers, wherein the voltage and scaling mode are associated with compute ability and power consumption associated with the plurality of servers.

7. The method of claim 1, wherein the optimization recommendations are configured to reduce carbon intensity values related to the computing system.

8. The method of claim 1, further comprises:
collecting a second set of training data based, in part, on the implemented optimization recommendations to manage the current state of the computer system; and
retraining, using the second set of training data, the machine learning model to optimize resource management of the computing system.

9. The method of claim 1, wherein the optimization recommendations include an optimized sleep state solution, wherein the optimized sleep state solution comprises a plurality of sleep state recommendations and a server availability schedule to be applied at run time for a plurality of servers of the computing system.

10. The method of claim 9, wherein the server availability schedule is implemented by a load balancer to a subset of servers of the plurality of servers of the computing system.

11. The method of claim 9, further comprising:
analyzing the plurality of sleep state recommendations of the optimized sleep state solution;
determining at least one sleep state recommendation of the plurality of sleep recommendations has been underutilized when implementing the optimized sleep state solution; and
refactoring the optimized sleep state solution by removing the at least one sleep state recommendation.

12. The method of claim 11, wherein the refactoring is initiated based on one or more rules being met.

13. The method of claim 12, wherein a first rule initiates refactoring if a given sleep state recommendation is not selected over a time period.

14. A machine learning based scheduling system comprising:
a processor; and
a computer-readable storage medium communicatively coupled to the processor and storing program instructions which, when executed by the processor, cause the processor to perform a method comprising:
generating training data from a retrospective analysis of historical resource management data associated with a computing system;
training a machine learning model to optimize resource management of the computing system at run time using the training data;
obtaining optimization recommendations for a current state of the computing system from the machine learning model; and
implementing the optimization recommendations to manage the current state of the computing system.

15. The system of claim 14, wherein generating the training data from the retrospective analysis of historical resource management data comprises:
collecting a set of historical data features from a plurality of servers associated with the computing system;
analyzing the set of historical data features to determine a sleep state solution for the plurality of servers, wherein the sleep state solution comprises a plurality of sleep state recommendations for the plurality of servers; and
generating the sleep state solution for managing sleep states for the plurality of servers, wherein the sleep state solution is used as the training data for the machine learning model.

16. The system of claim 15, wherein the historical data features are chosen from a group of data features consisting of: system state data, server characteristics, carbon intensity data, and server traffic/demand data.

17. The system of claim 14, wherein the optimization recommendations include an optimized sleep state solution, wherein the optimized sleep state solution comprises a plurality of sleep state recommendations and a server availability schedule to be applied at run time for a plurality of servers of the computing system.

18. A computer program product comprising a computer-readable storage medium having program instructions embodied therewith, the program instructions executable by a processor to cause the processor to perform a method comprising:
generating training data from a retrospective analysis of historical resource management data associated with a computing system;
training a machine learning model to optimize resource management of the computing system at run time using the training data;
obtaining optimization recommendations for a current state of the computing system from the machine learning model; and
implementing the optimization recommendations to manage the current state of the computing system.

19. The computer program product of claim 18, wherein generating the training data from the retrospective analysis of historical resource management data comprises:
collecting a set of historical data features from a plurality of servers associated with the computing system;
analyzing the set of historical data features to determine a sleep state solution for the plurality of servers, wherein the sleep state solution comprises a plurality of sleep state recommendations for the plurality of servers; and
generating the sleep state solution for managing sleep states for the plurality of servers, wherein the sleep state solution is used as the training data for the machine learning model.

20. The computer program product of claim 19, wherein the historical data features are chosen from a group of data features consisting of: system state data, server characteristics, carbon intensity data, and server traffic/demand data.
